(19) United States
(12) Patent Application Publication
(10) Pub. No.: US 2017/0326646 A1
(43) Pub. Date: Nov. 16, 2017

(54) ADDITIVE MANUFACTURING APPARATUS AND METHODS

(71) Applicant: RENISHAW PLC, Wotton-under-Edge, Gloucestershire (GB)

(72) Inventors: Michael Joseph MCCLELLAND, Stoke-on-Trent (GB); Ravi Guttamindapalli ASWATHANARAYANASWAMY, Stone (GB); Ceri BROWN, Bristol (GB)

(73) Assignee: RENISHAW PLC, Wotton-under-Edge, Gloucestershire (GB)

(21) Appl. No.: 15/527,961

(22) PCT Filed: Nov. 17, 2015
(86) PCT No.: PCT/GB2015/053483

§ 371 Date: May 18, 2017

(30) Foreign Application Priority Data
Nov. 21, 2014 (GB) 1420716.1

(51) Int. Cl. B22F 3/105; B33Y 10/00; B28B 1/00; B29C 67/00

(52) U.S. Cl. CPC B22F 3/1055; B33Y 10/00; B22F 2003/1057; B29C 67/00; B28B 1/00

(57) ABSTRACT

An additive manufacturing apparatus has a build chamber, a build platform lowerable in the build chamber such that layers of flowable material can be successively formed across the build platform, a laser for generating a laser beam, a scanning unit for directing the laser beam onto each layer to solidify the material in selected areas and a processor for controlling the scanning unit. The processor is arranged to control the scanning unit to direct the laser beam to solidify material of a layer along a scan path, the laser beam advanced along at least a section of the scan path in an opposite direction to a direction in which the laser beam is advanced along a corresponding section of a corresponding scan path of a previous layer. The scan path may be a border scan path extending around a border of one of the selected areas of the layer.

### FIELD OF INVENTION

This invention concerns additive manufacturing apparatus and methods in which layers of material are solidified in a layer-by-layer manner to form an object. The invention has particular, but not exclusive application, to selective laser solidification apparatus, such as selective laser melting (SLM) and selective laser sintering (SLS) apparatus.

### BACKGROUND

Selective laser melting (SLM) and selective laser sintering (SLS) apparatus produce objects through layer-by-layer solidification of a material, such as a metal powder material, using a high energy beam, such as a laser beam. A powder layer is formed across a powder bed in a build chamber by depositing a heap of powder adjacent to the powder bed and spreading the heap of powder with a wiper across (from one side to another side of) the powder bed to form the layer. A laser beam is then scanned across areas of the powder layer that correspond to a cross-section of the object being constructed. The laser beam melts or sinters the powder to form a solidified layer. After selective solidification of a layer, the powder bed is lowered by a thickness of the newly solidified layer and a further layer of powder is spread over the surface and solidified, as required. An example of such a device is disclosed in U.S. Pat. No. 6,042,774.

Typically, the laser beam is scanned across the powder along a scan path. An arrangement of the scan paths will be defined by a scan strategy. U.S. Pat. No. 5,155,324 describes a scan strategy comprising scanning an outline (border) of a part cross-section followed by scanning an interior (core) of the part cross-section. Scanning a border of the part may improve the resolution, definition and smoothing of surfaces of the part.

WO2014/0154878 discloses scanning a closed contour in which the contour is divided into separate vectors, wherein a direction each vector is scanned is based on an angle of the vector to a gas flow direction.

Parimi L., Aswathanarayanaswamy R., Clark D., Attallah M., “Microstructural and texture development in direct laser fabricated IN718”, Materials Characterization, Volume 89, March 2014, pages 102 to 111 discloses effects of unidirectional and bidirectional scan strategies on columnar grain structure of an IN718 SLM built part.

### SUMMARY OF INVENTION

According to a first aspect of the invention there is provided an additive manufacturing apparatus comprising a build chamber, a build platform lowerable in the build chamber such that layers of flowable material can be successively formed across the build platform, a laser for generating a laser beam, a scanning unit for directing the laser beam onto selected areas of each layer to solidify the material in the selected areas and a processor for controlling the scanning unit.

The processor may be arranged to control the scanning unit to direct the laser beam to solidify material of a layer along a scan path, the laser beam advanced along at least a section of the scan path in an opposite direction to a direction in which the or another laser beam is advanced along a corresponding section of a corresponding scan path of a previous layer.

The scan path may be a border scan path extending around a border of one of the selected areas of the layer, wherein the laser beam is advanced along at least the section of the border scan path in an opposite direction to a direction in which the or the other laser beam is advanced along a corresponding section of a corresponding border scan path of a corresponding selected area of the previous layer.

Advancing the laser beam along a border scan path of a selected area in this manner may reduce the size of columnar grain structures at a surface of a part being manufactured relative to advancing the laser beam along border scan paths of corresponding areas in successive layers in the same direction. Reducing long columnar grain structures at a surface of the part may result in a stronger part because cracks in a part tend to propagate from columnar grain structures having a large mismatch between height and width. Reducing long columnar grain structures at the surface therefore reduces the chance of the part cracking.

The laser beam may be advanced along an entire length of the scan path, such as a border scan path (a closed polyline), in the opposite direction (anticlockwise/clockwise) to the direction in which the or the other laser beam is advanced along an entire length of the corresponding scan path, such as the corresponding border scan path of the corresponding selected area, of the previous layer. This may be particularly advantageous for continuous scans of each border scan path as there will be only a single join (at the common start and the finish point).

Alternatively, the laser beam may be advanced along different sections of the scan path, such as the border scan path, in different directions. For example, WO2014/0154878 discloses how a border scan path may be divided into sections and the laser beam scanned along each section in a direction based on a gas flow direction of a gas knife. The laser beam may be advanced along two or more of the different sections in an opposite direction to a direction in which the or the other laser beam is advanced along the corresponding sections of the corresponding scan path, such as the corresponding border scan path of the corresponding selected area, of the previous layer. For some sections of the scan path, such as the border scan path, it may not be possible to both meet the requirements with regards the direction of a scan relative to the gas flow direction and be opposite to the direction the laser beam is advanced along the corresponding section of the corresponding scan path, such as the corresponding border scan path of the corresponding selected area, of the previous layer. For such sections, the laser beam may be scanned along the section in the same direction as the scan along the corresponding section of the corresponding scan path, such as corresponding border scan path of the corresponding selected area, of the previous layer.

The processor may be arranged to control the scanning unit to direct the laser beam to solidify adjacent border scan paths extending around the border of the selected area. The laser beam may be advanced along a section of one of the adjacent border scan paths in an opposite direction to a direction the or another laser beam is advanced along a corresponding section of the other of the adjacent border scan paths.

Advancing the laser beam along the adjacent border scan paths in this manner may reduce the size of grain structures at a surface of a part being manufactured relative to advancing the laser beam in the same direction along adjacent border scan paths. Reducing a size of grain structures at a surface of the part may result in a stronger part because cracks in a part tend to propagate from a mismatch in thermal shrinkage in different directions along the grain structures. Reducing a mismatch in dimensions of the grain structures reduces the chance of the part cracking.

The laser beam may be advanced along an entire length of one of the adjacent border scan paths in the opposite direction to a direction in which the or the other laser beam is advanced around an entire length of the other one of the adjacent border scan paths. This may be advantageous, as for continuous scanning of each border scan path there will be only a single join (at the common start and the finish point).

Alternatively, the laser beam may be advanced in different directions along different sections of one or each of the adjacent border scan paths. For example, WO2014/0154878 discloses how a border scan path may be divided into sections and the laser beam scanned along each section in a direction based on a gas flow direction of a gas knife. According to the invention, one or more of the different sections of one of the adjacent border scan paths may be scanned in a direction opposite to a direction the laser beam is scanned along the corresponding section of other of the adjacent border scan paths. For some sections of the adjacent border scan path it may not be possible to both meet the requirements with regards the direction of the scan relative to the gas flow direction and be opposite to the direction the laser beam is scanned along the corresponding section of other of the adjacent border scan paths. For such sections, the laser beam may be scanned along the corresponding sections of the other adjacent border scan path in the same direction.

The processor may be arranged to control the scanning unit to advance the laser beam along three, four or more border scan paths, which extend around a border of the area. The laser beam may be advanced along each one of the border scan paths extending around the border in an opposite direction (clockwise/anticlockwise) to a direction the laser beam is advanced around the adjacent border scan path(s).

The processor may be arranged to control the scanning unit to scan the laser beam along the border scan path of the selected area such that a start point or/and finish point of the scan is at a different location/are at different locations along the border to a start point or/and finish point of a scan along the border scan path of the corresponding selected area of the previous layer.

The start and/or end of a scan may produce a defect in the part due to the different melt conditions at the end points relative to other points of the scan. Offsetting the start and finish points for border scans of successive layers may reduce the size of defects formed at these points, reducing the chance of crack propagation from such defects.

The processor may be arranged to control the scanning unit to direct the laser beam to solidify material along adjacent border scan paths extending around a border of the selected area, a start point or/and finish point of the scan of one of the adjacent border scan paths is at a different location/are at different locations along the border to a start point or/and finish point of a scan along the other of the adjacent border scan paths.

The start and/or end of a scan may produce a defect in the part due to the different melt conditions at the end points relative to other points of the scan. Offsetting the start and finish points for adjacent border scans may reduce the size of defects formed at these points, reducing the chance of crack propagation through a layer from such defects.

The laser beam may be scanned along the entire length of one of the adjacent border scan paths (a closed polyline) in a single scan having a common start and finish point that is at a different location along the border to a common start and finish point of a single scan along the entire length of the other of the border scan paths. This may be advantageous as for each border scan path there will only be a single join (at the common start and the finish point).

Alternatively, the laser beam may be scanned along one of the adjacent border scan paths in a plurality of discrete scans, the start or/and finish points of two or more (and preferably, all) of the discrete scans being at a different location/different locations along the border to the start point or/and finish point of discrete scans along the other one of the adjacent border scan paths. For example, WO2014/0154878 discloses how a border scan path may be divided into sections and the laser beam scanned along each section in a direction based on a gas flow direction of a gas knife. End points of two or more (and preferably all) of the sections may be altered between adjacent border scan paths such that any defect formed at the start or end of the scan is not propagated through the layer of the part.

The processor may be arranged to control the scanning unit to direct the laser beam to solidify material along three, four or more border scan paths, which extend around a border of the selected area. A scan along each one of the border scan paths may have a start point or/and finish point at a different location/different locations along the border to a start point or/and finish point of a scan along the adjacent border scan path(s).

The processing unit may be arranged to control the scanning unit to scan the laser beam across a core of the selected area, within the border, along parallel scan paths. For example, a core may be scanned using the conventional scan strategies of a raster scan, checkerboard or stripe formations.

The apparatus may comprise a laser unit, optionally comprising a plurality of lasers, for generating a plurality of laser beams, wherein the laser beam used for scanning the scan path may be the same or a different laser beam to that used to scan the corresponding scan path of the previous layer.

According to a second aspect of the invention there is provided a method of scanning layers of material in a layer-by-layer additive manufacturing process, wherein successive layers of flowable material are formed across a build platform and a laser beam scanned across selected areas of each layer to consolidate the material in the selected areas.

The method may comprise directing the laser beam to solidify material of the layer along a scan path, such as a border scan path extending around a border of one of the selected areas, the laser beam advanced along at least a section of the scan path, such as the border scan path, in an opposite direction to a direction in which the or another laser beam is advanced along a corresponding section of a corresponding scan path, such as a corresponding border scan path, of a corresponding selected area of a previous layer.

The method may comprise directing the laser beam to solidify material along adjacent border scan paths extending around a border of one of the selected areas, the laser beam advanced along a section of one of the adjacent border scan paths in an opposite direction to a direction the or another laser beam is advanced along a corresponding section of the other of the adjacent border scan paths.

According to a third aspect of the invention there is provided a data carrier having instructions stored thereon, which, when executed by a processing unit of an additive manufacturing apparatus, cause the processing unit to control the additive manufacturing apparatus to carry out the method of the second aspect of the invention.

It will be understood that the term “scan” as used herein includes both moving a laser spot along a scan path in a continuous motion and switching of the laser beam on and off as the scanning unit advances the laser spot along a scan path (as is used in Renishaw's AM250 machine). In both cases, a solidification line, such as weld line, is formed continuously along the scan path. “Discrete scans” refers to separate scans wherein, between scans, there is a break in the continuous formation of a solidification line. However, a discrete scan may intersect (for example at end points) with another one of the discrete scans.

The data carrier of the above aspects of the invention may be a suitable medium for providing a machine with instructions such as non-transient data carrier, for example a floppy disk, a CD ROM, a DVD ROM/RAM (including −R/−RW and +R/+RW), an HD DVD, a Blu Ray(™) disc, a memory (such as a Memory Stick(™), an SD card, a compact flash card, or the like), a disc drive (such as a hard disc drive), a tape, any magneto/optical storage, or a transient data carrier, such as a signal on a wire or fibre optic or a wireless signal, for example a signals sent over a wired or wireless network (such as an Internet download, an FTP transfer, or the like).

### DESCRIPTION OF THE DRAWINGS

FIG. 1 is a schematic of a selective laser solidification apparatus according to an embodiment of the invention;

FIG. 2 is a schematic of the selective laser solidification apparatus from another side;

FIGS. 3a and 3b are schematic diagrams illustrating a scan along a scan path;

FIG. 4 is a schematic diagram illustrating border and fill scans across an area of a layer to be solidified in accordance with an embodiment of the invention;

FIG. 5 is a schematic diagram illustrating the change in end points and direction of scans along border scan paths between successive layers in accordance with an embodiment of the invention; and

FIG. 6 shows directions in which a laser beam is scanned along border scan paths in accordance with another embodiment of the invention.

### DESCRIPTION OF EMBODIMENTS

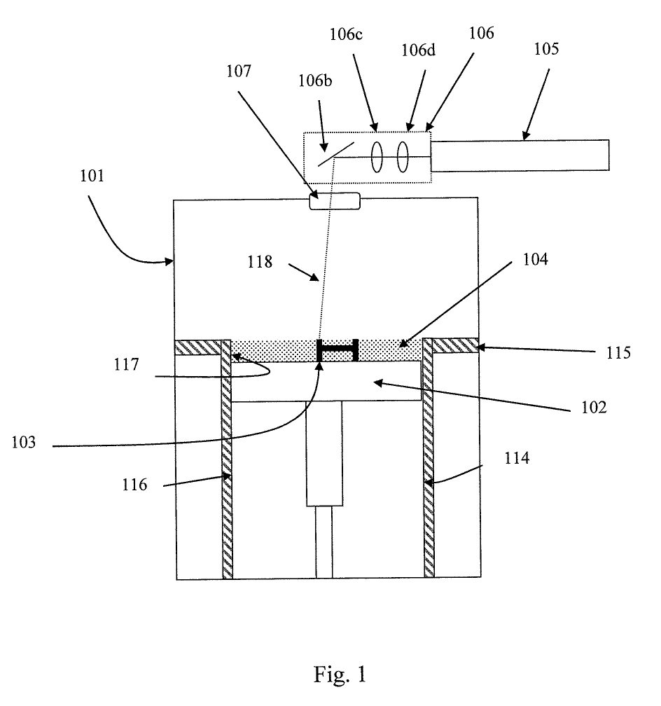

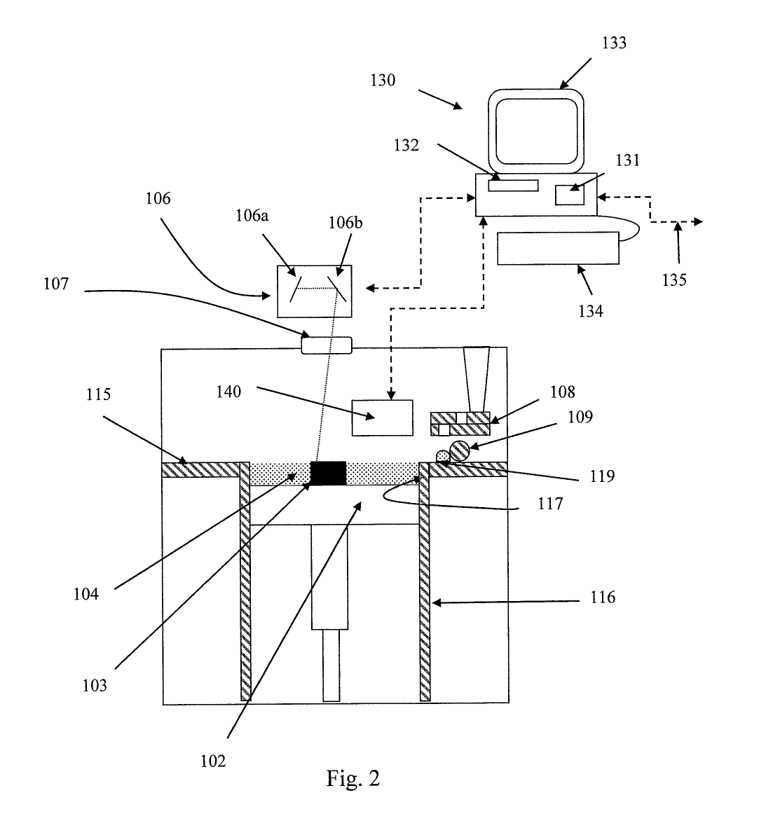

Referring to FIGS. 1 and 2, a laser solidification apparatus according to an embodiment of the invention comprises a main chamber 101 having therein partitions 115, 116 that define a build chamber 117 and a surface onto which powder can be deposited. A build platform 102 is provided for supporting an object 103 built by selective laser melting powder 104. The platform 102 can be lowered within the build chamber 117 as successive layers of the object 103 are formed. A build volume available is defined by the extent to which the build platform 102 can be lowered into the build chamber 117.

Layers of powder 104 are formed as the object 103 is built by dispensing apparatus 108 and an elongate wiper 109. For example, the dispensing apparatus 108 may be apparatus as described in WO2010/007396.

A laser module 105 generates a laser for melting the powder 104, the laser directed as required by optical scanner 106 under the control of a computer 130. The laser enters the chamber 101 via a window 107.

The optical scanner 106 comprises steering optics, in this embodiment, two movable mirrors 106a, 106b for directing the laser beam to the desired location on the powder bed 104 and focussing optics, in this embodiment a pair of movable lenses 106c, 106d, for adjusting a focal length of the laser beam. Motors (not shown) drive movement of the mirrors 106a and lenses 106b, 106c, the motors controlled by processor 131.

Computer 130 comprises the processor unit 131, memory 132, display 133, user input device 134, such as a keyboard, touch screen, etc, a data connection to modules of the laser melting unit, such as optical module 106 and laser module 105, the position measuring device 140 and an external data connection 135. Stored on memory 132 is a computer program that instructs the processing unit to carry out the method as now described.

Processor receives via external connection 135 geometric data describing scan paths to take in solidifying areas of powder in each powder layer. To build a part, the processor controls the scanner 106 to direct the laser beam in accordance with the scan paths defined in the geometric data.

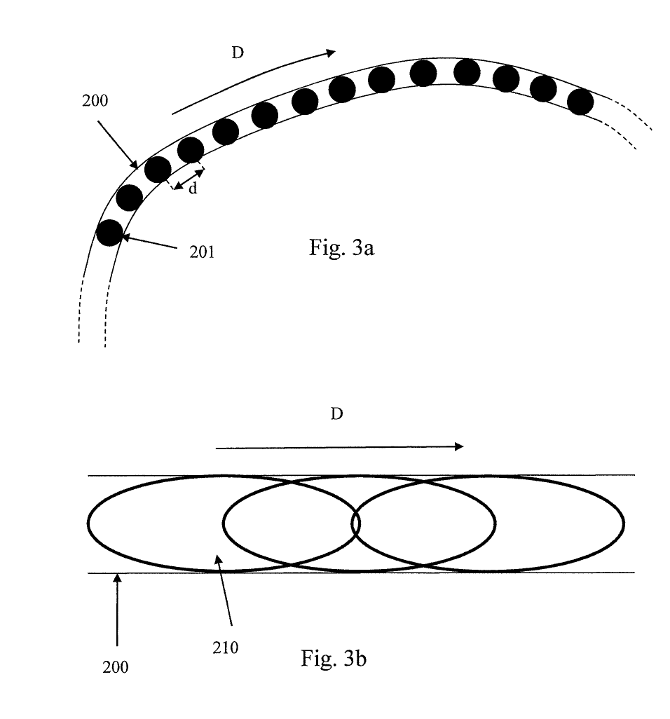

Referring to FIGS. 3a and 3b, in this embodiment, to perform a scan along a scan path, such as a border scan path 200, extending around an area of material to be solidified, the laser 105 and scanner 106 are synchronised to sequentially expose a series of discrete points 201 along the scan path 200 to the laser beam. For each scan path 200, a point distance, d, point exposure time, spot size and delay between each point exposure is defined. A direction, D, in which the points 201 are scanned is also defined. In FIG. 3a, a direction D in which the laser beam advances around the border scan path 201 is clockwise but, as described in more detail below, for other border scan paths, the laser beam may be advanced around the border scan path in an anticlockwise direction. In practice, the time between each point exposure is typically so short that the mirrors 106a, 106b are unable to move and stop quickly enough relative to the pulsed output of the laser to scan discrete spots as shown in FIG. 3a resulting in the formation of an elongated melt pool 210 for each discrete point, as shown schematically in FIG. 3b. Accordingly, instructions to exposure a series of discrete points, as shown in FIG. 3a results in the formation of a continuous line of solidified material along the scan path.

In an alternative embodiment, the spot may be continuously scanned along the scan path. In such an embodiment, rather than defining a point distance and exposure time, a velocity of the laser spot may be specified for each scan path.

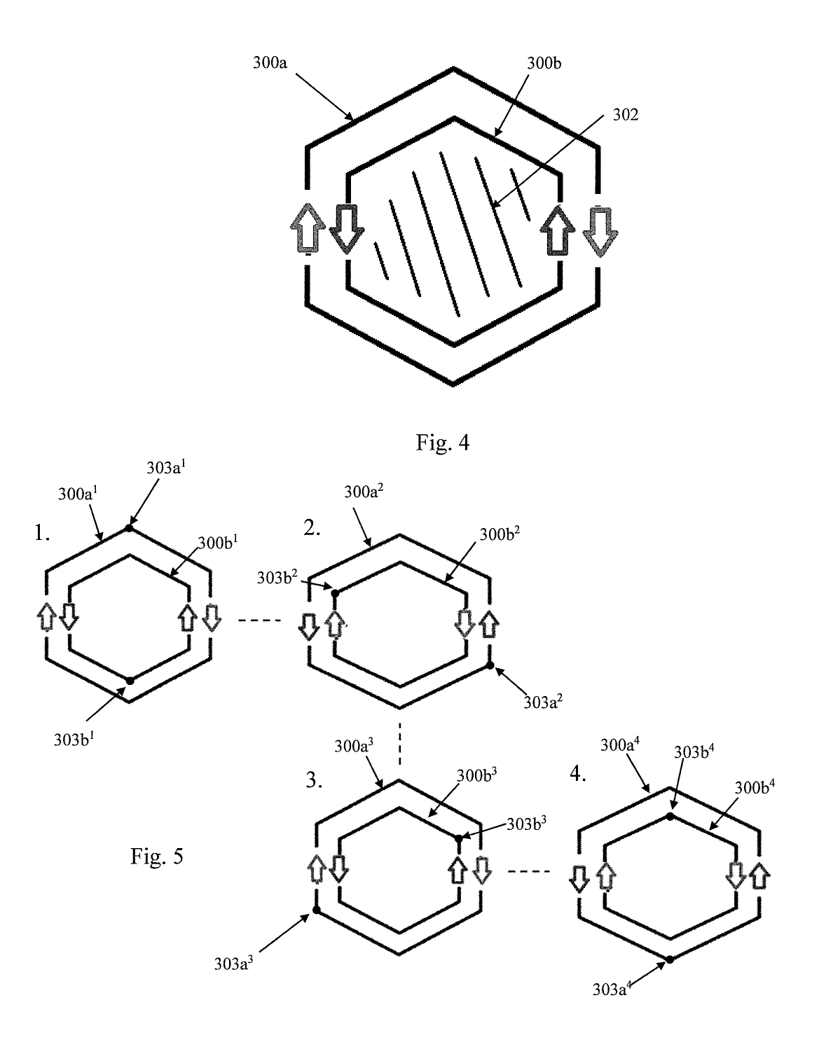

Referring to FIG. 4, scan paths 300a, 300b and 302 are shown for an area to be solidified in layer of material. The scan paths include an outer border scan path 300a and an inner border scan path 300b extending around a border of the area and a fill scan paths 302 for solidifying a core of the area. In FIG. 4, the fill scan paths 302 are shown as raster (meander) scans but it will be understood that other scan strategies could be used to fill a core of the area, such as scanning as a series of stripes or in a checkerboard pattern, as described in EP1993812 It is usually beneficial to use different scan strategies for the shell and core of the area in order to efficiently solidify the area whilst achieving accurate surfaces for the part.

As shown by the arrows in FIG. 4, the laser beam is advanced along the outer border scan path 300a in a clockwise direction opposite to the anticlockwise direction in which the laser beam is advanced along the inner border path 300b.

FIG. 5 shows how the direction the laser beam is advanced along corresponding border scan paths of corresponding areas of different layers 1, 2, 3, 4 is alternated between the clockwise and anticlockwise directions. Typically, the areas to be solidified between consecutive layers do not change dramatically because the part will usually be built in an orientation that avoids large step changes between layers. Accordingly, the areas to be solidified in a previous layer will typically closely correspond in size and shape to the areas to be solidified in the present layer.

In FIG. 5, the direction that the outer and inner border scan paths 300a, 300b are scanned with the laser beam is reversed for each layer 1, 2, 3, and 4 from the previous layer. Furthermore, a location of a start/finish position 303a, 303b for the scan of each border scan path 300a, 300b is altered from a location of the start/finish position of the scan of the corresponding border scan path 300a, 300b in the previous layer 1, 2, 3, 4. In FIG. 5, the fill scan paths are omitted for clarity, however, it will be understood that the fill scan paths are usually rotated by a set angle between layers, for example such that the fill scan paths of the current layer extend at an angle that is not divisible by 45, 60, 72 or 90 degrees to the fill scans of the previous layer. Typically, the angle of rotation between consecutive layers is greater than 10 degrees and is preferably an angle such as 67 or 74 degrees.

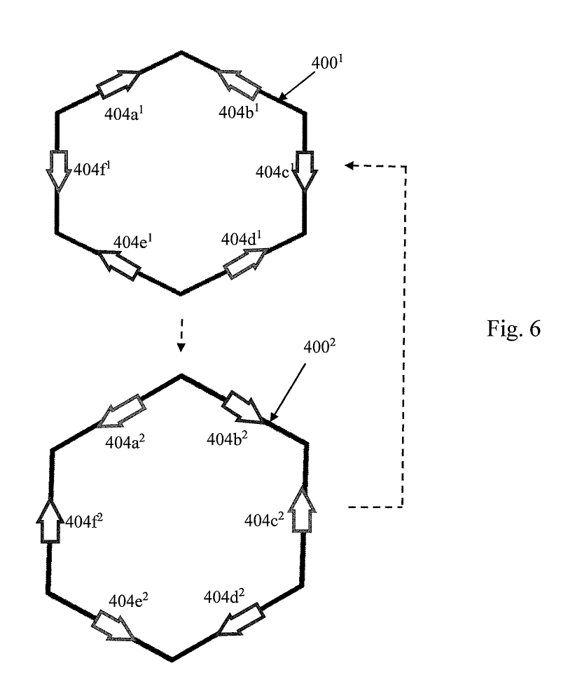

FIG. 6 shows border scan paths for consecutive layers according to an alternative embodiment of the invention. In this embodiment, material along a border scan path 400 is solidified by carrying out a series of discrete scans along different, in this case six, sections 404a to 404f of the border scan path 400. Different sections 404a to 404f are scanned in different directions around the border scan path 400 (clockwise/anticlockwise). The direction in which the laser beam is scanned along each section 404a² to 404f² of a border scan path 400² is opposite to a direction the laser beam is scanned along a corresponding section 404a¹ to 404f¹ of a corresponding border scan path 400¹ of the previous layer.

In the case where multiple border scan paths 400 are carried out in the solidification of an area, the material along each of the border scan paths may be solidified by carrying out a series of discrete border scans. Start and finishing points for each discrete scan for one of the border scan paths may be at different locations along the border to a start point or/and finish point of the discrete scans along the adjacent border scan path(s).

It will be understood that alterations and modifications may be made to the above described embodiments without departing from the scope of the invention as defined herein. For example, the invention may be extended to non-border scans which are substantially repeated in consecutive layers. For example, US2015/0151491 discloses an arrangement in which a shape of a set of paths to be travelled by a laser beam in the formation of a 2-dimensional section depend on the geometric shape of the contour of the section. For consecutive layers having the same or similar 2-dimensional sections/areas to be formed, the direction in which corresponding ones of the paths are travelled by the laser beam may be reversed between the consecutive layers. Furthermore, the apparatus may comprise a plurality of lasers for generating a plurality of laser beams and, for each laser beam, a scanning module for directing the laser beam to selected areas of the powder bed, wherein, the laser beam used for scanning the scan path 300a, 300b, 400 may be the same or a different one of the laser beams used to scan the corresponding scan path 300a, 300b, 400 of the previous layer.

1. An additive manufacturing apparatus comprising a build chamber, a build platform lowerable in the build chamber such that layers of flow able material can be successively formed across the build platform, a laser for generating a laser beam, a scanning unit for directing the laser beam onto each layer to solidify the material in selected areas and a processor for controlling the scanning unit, wherein the processor is arranged to control the scanning unit to direct the laser beam to solidify material of a layer along a scan path, the laser beam advanced along at least a section of the scan path in an opposite direction to a direction in which the or another laser beam is advanced along a corresponding section of a corresponding scan path of a previous layer.

2. An additive manufacturing apparatus according to claim 1, wherein the scan path is a border scan path extending around a border of one of the selected areas of the layer, wherein the laser beam is advanced along at least the section of the border scan path in an opposite direction to a direction in which the or the other laser beam is advanced along a corresponding section of a corresponding border scan path of a corresponding selected area of the previous layer.

3. An additive manufacturing apparatus according to claim 1, wherein the processor is arranged to control the scanning unit to
advance the laser beam along an entire length of the scan path in the opposite direction to the direction in which the or the other laser beam is advanced along an entire length of the scan path of the corresponding selected area of the previous layer.

4. An additive manufacturing apparatus according to claim 1, wherein the processor is arranged to control the scanning unit such that the laser beam is advanced along different sections of the scan path in different directions.

5. An additive manufacturing apparatus according to claim 4, wherein the processor is arranged to control the scanning unit such that the laser beam is advanced along two or more of the different sections in an opposite direction to a direction in which the or the other laser beam is advanced along the corresponding sections of the corresponding scan path of the previous layer.

6. An additive manufacturing apparatus according to claim 1, wherein the processor is arranged to control the scanning unit to direct the laser beam to solidify adjacent border scan paths extending around the border of the selected area.

7. An additive manufacturing apparatus according to claim 6, wherein the processor is arranged to control the scanning unit to advance the laser beam along a section of one of the adjacent border scan paths in an opposite direction to a direction the or another laser beam is advanced along a corresponding section of the other of the adjacent border scan paths.

8. An additive manufacturing apparatus according to claim 7, wherein the processor is arranged to control the scanning unit to advance the laser beam along an entire length of one of the adjacent border scan paths in the opposite direction to a direction in which the or the other laser beam is advanced around an entire length of the other one of the adjacent border scan paths.

9. An additive manufacturing apparatus according to claim 7, wherein the processor is arranged to control the scanning unit to advance the laser beam in different directions along different sections of one or each of the adjacent border scan paths.

10. An additive manufacturing apparatus according to claim 6, wherein the processor is arranged to control the scanning unit to direct the laser beam to solidify material along three, four or more border scan paths extending around the border of the selected area.

11. An additive manufacturing apparatus according to claim 10, wherein the laser beam is advanced around each one of the border scan paths in an opposite direction to the adjacent border scan path(s).

12. An additive manufacturing apparatus according to claim 6, wherein the processor is arranged to control the scanning unit to advance the laser beam along each of the adjacent border scan paths in a plurality of discrete scans, wherein a start point or/and finish point of each discrete scan for one of the adjacent border scan paths is at a different location/are at different locations along the border to a start point or/and finish point of a discrete scan along at least a corresponding section of the other of the adjacent border scan paths.

13. An additive manufacturing apparatus according to claim 2, wherein the processing unit is arranged to control the scanning unit to scan the laser beam across a core of the selected area, within the border, along parallel scan paths.

14. A method of scanning layers of material in a layer-by-layer additive manufacturing process, wherein successive layers of flowable material are formed across a build platform and a laser beam directed to selected areas of each layer to solidify the material in the selected areas, the method comprising directing the laser beam to solidify material along a scan path of a layer, the laser beam advanced along at least a section of the scan path in an opposite direction to a direction in which the or another laser beam is advanced along a corresponding scan path of a previous layer.

15. A data carrier having instructions stored thereon, which, when executed by a processing unit of an additive manufacturing apparatus, cause the processing unit to control the additive manufacturing apparatus to carry out the method of claim 14.
